(19) United States
(12) Patent Application Publication
(10) Pub. No.: US 2025/0252642 A1
(43) Pub. Date: Aug. 7, 2025

(54) INTERACTION METHOD, MEDIUM AND ELECTRONIC DEVICE

(71) Applicant: Beijing Zitiao Network Technology Co., Ltd., Beijing (CN)

(72) Inventors: Denglin JI, Beijing (CN); Li ZHONG, Beijing (CN)

(21) Appl. No.: 18/959,492

(22) Filed: Nov. 25, 2024

(30) Foreign Application Priority Data
Feb. 4, 2024 (CN) 202410160809.4

(51) Int. Cl. G06T 13/40; G06T 17/00

(52) U.S. Cl. CPC G06T 13/40; G06T 17/00

(57) ABSTRACT

An interaction method, a medium, and an electronic device are provided. The method includes: in response to an interactive operation of a user on a target virtual character in a virtual scene interface, acquiring interaction information corresponding to the interactive operation; according to the interaction information and character information corresponding to the target virtual character, generating an interaction text corresponding to the target virtual character, in which the character information corresponding to the target virtual character includes character setting information and memory information of the target virtual character, the memory information includes event information and conversation information of the target virtual character within a historical period of time; and controlling the target virtual character to output the interaction text.

### CROSS-REFERENCE TO RELATED APPLICATION

This application claims the priority of Chinese Patent Application No. 202410160809.4, filed on Feb. 4, 2024, the disclosure of which is incorporated by reference herein in its entirety as part of the present application.

### TECHNICAL FIELD

Embodiments of the present disclosure relate to the field of computer technology, and in particular, to an interaction method, an apparatus, a medium, and an electronic device.

### BACKGROUND

An open-domain conversation system refers to a system with which a user can perform conversation interaction in a certain environment. The system can give a meaningful reply to a conversation sent by the user, and the topic of the conversation is not restricted by purpose and topic.

With the in-depth research of natural language processing, the open-domain conversation in the related art is mainly implemented through an end-to-end conversation generation model. In the interaction scenario of an NPC (non-player character), the related art generally performs static setting on a virtual character, and in the conversation process, the reply of the NPC to the input of the user is usually determined based on the current conversation context.

### SUMMARY

The Summary is provided to introduce concepts in a brief form, the concepts will be described in detail in the following Description of Embodiments. The Summary is not intended to identify key features or essential features of the claimed technical solution, nor is it intended to be used to limit the scope of the claimed technical solution.

In a first aspect, the embodiments of the present disclosure provide an interaction method, which includes:
in response to an interactive operation of a user on a target virtual character in a virtual scene interface, acquiring interaction information corresponding to the interactive operation;
according to the interaction information and character information corresponding to the target virtual character, generating an interaction text corresponding to the target virtual character, in which the character information corresponding to the target virtual character includes character setting information and memory information of the target virtual character, the memory information includes event information and conversation information of the target virtual character within a historical period of time; and
controlling the target virtual character to output the interaction text.

In a second aspect, the embodiments of the present disclosure provide an interaction apparatus, which includes:
an obtaining module, configured to, in response to an interactive operation of a user on a target virtual character in a virtual scene interface, acquire interaction information corresponding to the interactive operation;
a first generation module, configured to, according to the interaction information and character information corresponding to the target virtual character, generate an interaction text corresponding to the target virtual character, in which the character information corresponding to the target virtual character includes character setting information and memory information of the target virtual character, the memory information includes event information and conversation information of the target virtual character within a historical period of time; and
a first control module, configured to control the target virtual character to output the interaction text.

In a third aspect, the embodiments of the present disclosure provide a computer-readable medium having a computer program stored thereon, when the program is executed by a processing apparatus, steps of the method in the first aspect are implemented.

In a fourth aspect, the present disclosure provides an electronic device, which includes:
a storage apparatus having a computer program stored thereon; and
a processing apparatus, configured to execute the computer program in the storage apparatus to implement steps of the method in the first aspect.

### BRIEF DESCRIPTION OF DRAWINGS

The above and other features, advantages and aspects of various embodiments of the present disclosure will become more apparent when taken in conjunction with the drawings and with reference to the following description of embodiments. Throughout the drawings, the same or similar reference numbers refer to the same or similar elements. It should be understood that the drawings are schematic and the components and elements are not necessarily drawn to scale. In the drawings:

FIG. 1 is a flowchart of an interaction method provided according to an embodiment of the present disclosure.

FIG. 2 is a schematic diagram of an interaction flow provided according to an embodiment of the present disclosure.

FIG. 3 is a block diagram of an interaction apparatus provided according to an embodiment of the present disclosure.

FIG. 4 shows a schematic structural diagram of an electronic device suitable for implementing an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between multiple apparatuses in the implementations of the present disclosure are only for illustrative purposes, and are not used to limit the scope of these messages or information.

It can be understood that before the technical solution disclosed in each embodiment of the present disclosure is used, the user should be informed of the type, use scope, use scenario, and the like of the personal information involved in the present disclosure in an appropriate manner in accordance with relevant laws and regulations, and the user's authorization should be obtained.

For example, when a user's active request is received, prompt information is sent to the user to explicitly prompt the user that the operation requested by the user will need to obtain and use the user's personal information. Therefore, the user can independently choose whether to provide personal information to software or hardware such as an electronic device, an application, a server, or a storage medium that executes the operation of the technical solution of the present disclosure based on the prompt information.

As an optional but non-limiting implementation, in response to receiving the user's active request, for example, the prompt information may be sent to the user in a pop-up window, and the prompt information may be presented in the pop-up window in text. In addition, the pop-up window may also carry a selection control for the user to select “agree” or “disagree” to provide personal information to the electronic device.

It can be understood that the above notification and user authorization obtaining process are only illustrative and do not limit the implementations of the present disclosure. Other methods that comply with relevant laws and regulations may also be applied to the implementations of the present disclosure.

In addition, it can be understood that the data involved in this technical solution (including but not limited to the data itself, the acquisition or use of data) should comply with the requirements of corresponding laws and regulations and related regulations.

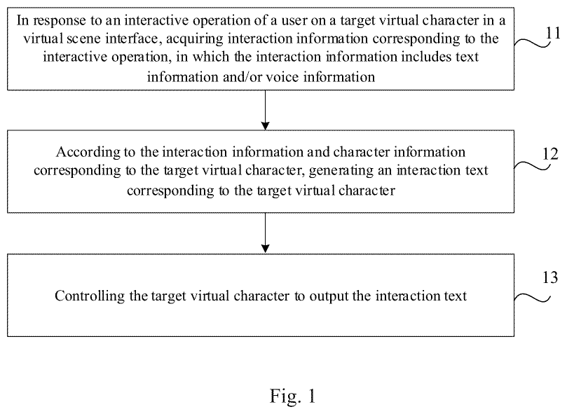

FIG. 1 is a flowchart of an interaction method provided according to an embodiment of the present disclosure. As shown in FIG. 1, the method may include the following steps.

In step 11, in response to an interactive operation of a user on a target virtual character in a virtual scene interface, acquiring interaction information corresponding to the interactive operation, in which the interaction information includes text information and/or voice information.

The virtual scene interface may be an environmental interface where a virtual character is located and is rendered in a computer, such as a game scene interface. The virtual character may be a non-player character, that is, an NPC, which can be controlled by a computer, and one or more NPCs are configured in the virtual scene in a pre-configured manner. Each NPC can perform corresponding operations based on its pre-generated basic plan.

As an example, when the user does not participate in the interaction, the virtual character can be controlled in the virtual scene interface according to its corresponding basic plan. For example, the virtual character VA may be a clerk in a bakery, based on the basic plan, the virtual character VA can be controlled to perform actions such as cleaning and making bread in the bakery.

In the embodiments of the present disclosure, the user can control his corresponding player character to act in the virtual scene to interact with other player characters or virtual characters in the virtual scene. For example, when the user U1 controls the player character B to walk towards the virtual character VA, and the distance between them is less than a distance threshold, the virtual character VA can be triggered to display an interaction button, and the user can click the interaction button to trigger an interactive operation with the virtual character VA, then the virtual character VA can be taken as the target virtual character. For example, the user can input text “What kind of song do you like?”, and the virtual character VA can respond to the input of the user.

In step 12, according to the interaction information and character information corresponding to the target virtual character, generating an interaction text corresponding to the target virtual character, in which the character information corresponding to the target virtual character includes character setting information and memory information of the target virtual character, the memory information includes event information and conversation information of the target virtual character within a historical period of time.

The interaction text is the text that the target virtual character uses to interact with the user, that is, the reply to the input of the user. The character information may be information used to describe the target virtual character, for example, it may include character setting information and memory information of the target virtual character. For example, the character setting information may be the setting of the personality, relationships and the like of the target virtual character, and the memory information may represent the experiences of the target virtual character within a historical period of time, such as historical conversations and historical events performed by the target virtual character. In this step, the interaction text is generated based on the character information and the interaction information, which can further improve the matching degree of the interaction text with the target virtual character, while improving the personification of the interaction text.

In step 13, controlling the target virtual character to output the interaction text.

As an example, controlling the target virtual character to output the interaction text may be displaying the interaction text in the form of a conversation bubble at a conversation position corresponding to the target virtual character, so that the user can view the interaction text displayed in the interface to achieve interaction with the target virtual character. As another example, controlling the target virtual character to output the interaction text may be outputting in the form of voice. For example, a voice corresponding to the interaction text can be generated based on the interaction text and a voice synthesis technology, and then the voice is output to achieve voice interaction with the user. Optionally, the interaction text and the voice may be output together. The specific output manner can be set based on actual application scenarios, and the embodiments of the present disclosure are not limited in this aspect.

Through the above technical solutions, the user can have a conversation with the NPC in the virtual scene interface. When the NPC determines the content to reply to the user, the NPC can make the determination based on its own settings and historical memory, so that the determined interaction text can have different memories for different users, which improves the personalization of the interaction with the NPC, and at the same time allows the NPC to maintain a certain setting for different users or at different times, thereby improving the stability and personification of the NPC, and thus improving the consistency of the interaction of the NPC and ensuring the consistency of the conversation of the virtual character. Thus, in the process of controlling the virtual character to perform in the virtual scene, the player character can participate in the conversation interaction of the virtual character in real time, which further improves the diversity and interaction experience of the user.

In a possible embodiment, the memory information includes long-term memory information and short-term memory information, the long-term memory information includes the event information and the conversation information, and the short-term memory information includes a conversation context corresponding to the user. For the specific content of the above specific information, reference may be made to the description below.

Correspondingly, generating the interaction text corresponding to the target virtual character according to the interaction information and the character information corresponding to the target virtual character may include:
based on the interaction information, retrieving, from the long-term memory information, associated memory information corresponding to the interaction information, and adding the associated memory information to the conversation context.

As an example, the interaction information may be matched with the long-term memory information. For example, the matching may be performed based on the calculation of similarity between feature vectors. When the similarity between the interaction information and the long-term memory information is greater than a similarity threshold, the long-term memory information corresponding to the similarity may be considered as the associated memory information corresponding to the interaction information. The similarity threshold may be set based on actual application scenarios, and the embodiments of the present disclosure are not limited in this aspect.

Correspondingly, the interaction text is subsequently generated according to the character setting information, the interaction information, and the short-term memory information.

In this embodiment, a prompt may be constructed based on the character setting information, the interaction information, and the short-term memory information, to generate the corresponding interaction text based on an LLM (Large Language Model).

As an example, the short-term memory information may further include one or more from a group consisting of current state information of the target virtual character, environmental information of a current environment, and the basic plan. When the interaction text is determined, the interaction text may also be generated in combination with the above information, to further improve the accuracy of the interaction text, avoid the occurrence of an interaction text that does not conform to the current characteristics of the target virtual character, and improve the personification of the interaction with the user.

Thus, through the above technical solutions, the memory information can be divided into long-term memory information and short-term memory information for separate storage, thereby avoiding an excessive amount of computation caused by an excessive amount of memory data and improving the efficiency of interaction text generation. Meanwhile, when the interaction text is generated, the associated memory information can be retrieved from the long-term memory information, thereby avoiding generation errors of the interaction text caused by memory loss to a certain extent, and at the same time, in combination with the character setting information, the personalized experience of the conversation interaction can also be improved.

In a possible embodiment, the short-term memory information further includes a basic plan of the target virtual character, the basic plan is used to control an action of the target virtual character, and the basic plan is determined by:
acquiring character setting information of the target virtual character, and according to the character setting information and a candidate position list corresponding to the target virtual character, generating various plans to be processed corresponding to the target virtual character.

Exemplarily, the basic plan corresponding to the virtual character in the next planning cycle may be generated offline. The planning cycle corresponding to the basic plan may be set based on an actual application scenario. For example, the planning cycle may be set to 1 day, and the 1 day is used to represent 1 day in virtual time in the virtual environment. That is, the basic plan may represent the plan corresponding to the virtual character in its corresponding 1 day of virtual time, such as what plan or what action can be performed, etc., to control the action of the virtual character, so that the virtual character in the virtual scene interface can perform action display according to the basic plan.

As an example, the character setting information includes basic setting information and immediate setting information, the basic setting information is used to represent attribute information of the target virtual character that remains unchanged during an interaction process, and the immediate setting information is used to represent attribute information of the target virtual character that changes during the interaction process.

For example, the basic setting information may include one or more from a group consisting of identity description information, personality information, character target information and relationship information. Among them, the identity description information is used to represent the identity setting of the virtual character, such as information about occupation, in-game background, family members, and the like. The personality information is used to represent the personality of the virtual character, and the personality information enables the same virtual character to maintain a consistent person setting in different scenarios or when having conversations with different characters. The character target information is used to represent a specific target of the virtual character. For example, the virtual character may have a specific identity and functional positioning. For example, when the identity of the NPC is an ice cream shop owner, its character target may be to take the initiative to greet the player and then sell the items in the ice cream shop to the player after the player enters the ice cream shop. Based on this character target, the behavior of the virtual character can be planned more accurately. The relationship information can be used to represent the relationship between different virtual characters. For example, virtual characters VA1 and VA2 are husband and wife, which can affect behavioral interaction and plot generation between different NPCs, and may also affect the relationship between NPCs and players through social networks.

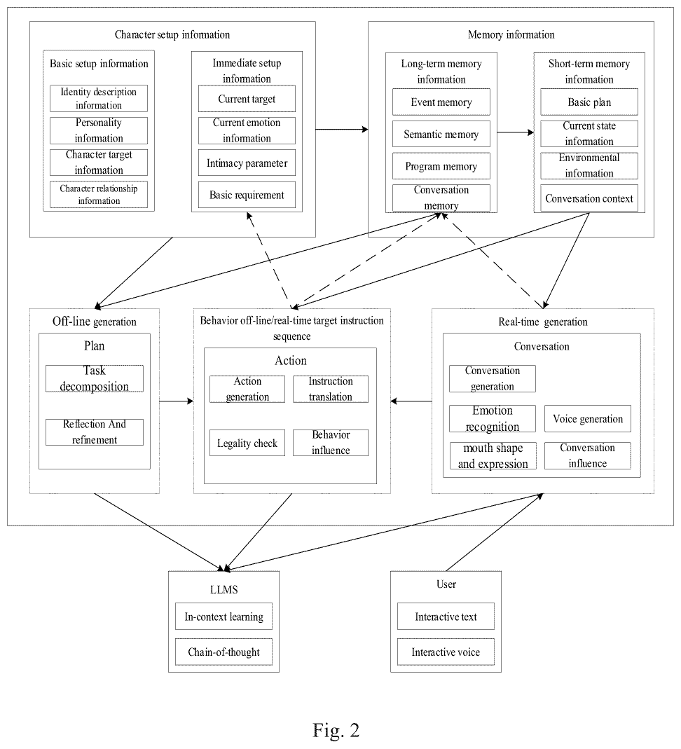

For example, the immediate setting information may include one or more from a group consisting of a current target, current emotion information, an intimacy parameter, and a basic requirement. Among them, the current target may be used to represent the immediate target of the virtual character, for example, what the current plan is, and it may be a null value when the basic plan is determined. When the virtual character is controlled to perform an operation based on the basic plan, the current target may represent the plan to be performed by the virtual character in the basic plan at present, which may have an impact on the theme of the content generated for the virtual character in the current round. The current emotion information may be used to represent the current emotion of the virtual character. When controlling the virtual character to perform interaction, the emotion of the interaction text output by the virtual character in the previous round may be taken as the emotion of the current round, that is, the current emotion, which may affect the style of the content generated by the virtual character in the current round. The intimacy parameter may be used to represent the intimate relationship constructed between the virtual character and other characters (NPCs/player characters). For example, the intimate relationship may be constructed through conversation or behavior. For example, in a conversation scenario, the intimacy parameter may be dynamically adjusted in combination with conversation rounds and emotional tendencies of the conversation content. For example, in a behavioral scenario, behaviors such as giving an item may be quantified to dynamically adjust the intimacy parameter. As an example, different intimate relationships may affect plot/behavior generation. The basic requirement may be used to represent the basic state of the virtual character. For example, it may be combined with the style corresponding to the virtual scene and the needs of the plot background to perform numerical setting on some basic requirement states of the virtual character, such as requirement values of health, energy, social interaction, entertainment, satiety, etc., which can make the behavior of the virtual character more personified, for example, eating food to overcome hunger, and engaging in social activities to relieve loneliness, etc. The character setting information is shown in FIG. 2.

In this embodiment, for any virtual character, a corresponding prompt may be constructed based on the character setting information of the virtual character and the candidate position list corresponding to the target virtual character, so that the various plans to be processed corresponding to the target virtual character may be generated based on the LLM model. For example, the format of the output plan may be given in the form of an example in the prompt, as follows:

Example for plan:
Here is Jack's plan from now at 7:45:
{“Location”: “restaurant”, “Plan”: “Go to restaurant for breakfast”, “From”: “7:45”, “To”: “8:35”}
{“Location”: “school”, “Plan”: “Go to school for study”, “From”: “8:35”, “To”: “12:00”}
. . .
{“Location”: “home”, “Plan”: “Go back home to play CSGO”, “From”: “16:35”, “To”: “22:35”}.

The plan to be processed may be a coarse-grained plan, so that the generated plan to be processed is consistent with the person setting and requirement target of the virtual character.

Then, memory information of the target virtual character is acquired, and according to the memory information and the various plans to be processed, an action corresponding to each of the plans to be processed performed by the target virtual character is generated.

When the plan to be processed of the virtual character is determined, finer-grained task decomposition may be performed for each plan to be processed, to obtain an action corresponding to the target virtual character when performing the plan to be processed.

As an example, in this step, the behavior generation may be further performed in combination with the memory information of the virtual character, so that the behavior generation of the plan to be processed is consistent with the historical memory of the virtual character, ensuring the consistency of the behaviors of the virtual character, and improving the personification of the virtual character.

The memory information may include long-term memory information and short-term memory information, the long-term memory information enables the virtual character to have the ability to store and retrieve historical information for a long time, which may be implemented through external carrier storage and rapid retrieval. The retrieval may usually be based on dimensions such as relevance, importance, and time, and long-term memories may be summarized through a regular reflection mechanism. Reflection is considered to be the key to dynamic languages, and the reflection mechanism allows programs to obtain internal information of any class with the help of the Reflection API during execution, and to directly operate internal attributes and methods of any object, which may be summarized based on general implementations in the art, and the embodiments of the present disclosure are not limited in this aspect.

As an example, the long-term memory information may include at least one from a group consisting of event memory, semantic memory, program memory, and conversation memory. Among them, the event memory may be used to represent the memory data of events that the virtual character has done and seen. The semantic memory may be used to represent the semantic knowledge memory of the virtual character to the game world, such as world view settings, hobbies, birthdays, relationships of other virtual characters, and other information, which may be obtained through summarizing the character setting information of the virtual character, or may be obtained through summarizing historical conversation information of the virtual character. The program memory may be used to represent the unique routine behavior of the virtual character, such as taking a walk after a meal, police patrol, etc., which may be obtained through reflection and summarization of the behavior of the virtual character. The conversation memory may be used to represent the historical conversation information corresponding to the virtual character, which may include the conversation memory between virtual characters, and the conversation memory between virtual characters and player characters.

As an example, the short-term memory information may include at least one from a group consisting of the basic plan, the current state information, the environmental information of the current environment, and the conversation context corresponding to the user, which can be used for conversation generation for decision-making in the current round of the virtual character. Among them, the basic plan may be used to represent various behaviors of the virtual character in its planning cycle, and when making decisions in the current round, such as conversation generation, the combination of the basic plan can make a clear perception of the plan of the virtual character itself, and ensure the consistency between the conversation content and the behavior of the virtual character itself. The current state information may be used to represent the state of the virtual character during real-time interaction, for example, it may be the action that the virtual character is currently doing. The environmental information of the current environment may be used to represent the environmental information of the environment where the virtual character is located during real-time interaction, such as the game time and the virtual objects in the environment. The virtual objects may be, for example, items and buildings, etc. Since the surrounding environment may change during the interaction process, the combination of the surrounding environment during task decomposition may also enable the generated behavior to adapt to environmental changes. The conversation context corresponding to the user may include the conversation context when the virtual character is interacting, which includes not only the context of the real conversation content, but also the context-related information retrieved from the long-term memory information. The memory information is shown in FIG. 2.

In this step, a prompt may be constructed based on the memory information and the plans to be processed, so as to generate a corresponding action based on the LLM. The memory information may include part or all of the memories described above, and the range of the selected memory may be preset based on the actual application scenario, for example, the M pieces of memory information that are closest in time are selected. As an example, the prompt may also include character setting information to further improve the accuracy of the generated behavior and the consistency of the person setting of the virtual character.

When constructing the prompt, the format of the output behavior may be restricted in the form of an example. For example, in the LLM model, the prompt may be constructed in a way of in-context learning (ICL) and chain-of-thought (CoT). Examples are as follows:

Example for John's actions for plan “waking up and complete the morning routine”, starting from 7:15 to 8:45 (total duration in minutes: 90):
{“Action”: “stretching and meditating”, “Location”: “double_sofa”, “From”: “7:15”, “To”: “7:25”, “Duration”: 10} (Duration in minutes: 10, minutes left: 80)
{“Action”: “grab breads from refrigerator”, “Location”: “refrigerator”, “From”: “7:25”, “To”: “7:30”, “Duration”: 5} (Duration in minutes: 5, minutes left: 75)
. . .
{“Action”: “have a cup of coffee”, “Location”: “coffee_table”, “From”: “8:35”, “To”: “8:45”, “Duration”: 10} (Duration in minutes: 10, minutes left: 0)

Therefore, the basic plan corresponding to the virtual character may be generated based on the LLM according to the character setting information and the memory information. In this process, the task decomposition is performed in a hierarchical manner. First, a coarse-grained plan to be processed is generated, and then a fine-grained semantic action is generated, that is, an action represented at the semantic level is generated. Therefore, the accuracy and rationality of the generated basic plan can be ensured through the hierarchical manner, thereby ensuring the rationality and smoothness of the behavior and action of the virtual character.

As an example, the generated semantic action may be refined through reflection to extract high-level information to be added to the memory information. Based on the reflection mechanism, the virtual character may regularly perform self-criticism and self-reflection on past behaviors, extract high-level information from them, and add the high-level information to the long-term memory information, so as to provide a data reference for the subsequent basic plan. Reflection and refinement can help the virtual character improve its intelligence and adaptability, thereby improving the accuracy of controlling the virtual character.

Then, an instruction sequence corresponding to each action may be generated, and the instruction sequence(s) may be spliced based on time information corresponding to the action(s) to obtain the basic plan.

As an example, in this step, the action generation may be performed according to the semantic action generated in the previous step. For each action, an action sequence that can be completed may be generated in combination with the virtual object in the virtual scene first, and then the action sequence may be translated into an instruction sequence that can be executed by the virtual object. However, the actions of the virtual character in the game scene are usually completed by calling a combination of underlying APIs. Instructions that can be freely combined to complete specific actions may be developed based on the underlying APIs, so as to translate the action sequence into an instruction sequence that can be executed by a program. The instruction translation may be implemented through the LLM model in combination with candidate instructions executable by the virtual character.

Then, in order to ensure the executability of the instruction sequence, its legality may be verified. Due to the uncontrollability of the LLM model generation, the result obtained from the instruction translation may include an illegal instruction, and an erroneous instruction may cause an error in the behavior of the virtual character. Therefore, in this embodiment, the legality verification may be further performed in combination with the virtual object in the virtual scene. For example, it may be determined, based on the virtual object, whether the instruction parameter required by each instruction is satisfied, and if so, it means that the legality verification is passed, thereby ensuring the legality and coherence of the behavior of the virtual character. After passing the legality verification, the instruction sequence corresponding to the action performed by the virtual character may be generated. The basic plan corresponding to the virtual character, that is, a specific action list of the virtual character on the current day, may be obtained by splicing the instruction sequences corresponding to the respective actions. Optionally, the immediate setting information and the memory information may be updated based on the basic plan. As shown by the dotted line in FIG. 2, the behavior may further update the character setting information and the memory information.

As an example, controlling the virtual character to execute the instruction in the target instruction sequence may be driving the virtual character to complete the instruction through a computer. An instruction executor may be configured based on an API opened in an application corresponding to the virtual scene, and the instruction executor may be mounted in the application as a global service to be executed by a program of the application.

Through the above technical solutions, the task decomposition can be performed in a hierarchical manner. First, a coarse-grained plan to be processed is generated, and then a fine-grained semantic action is generated, so as to ensure the accuracy and rationality of the basic plan and improve the accuracy of controlling the virtual character. Further, the action can be translated into an instruction sequence that can be executed by the instruction executor, thereby improving the smoothness of controlling the virtual character.

In a possible embodiment, the immediate setting information of the virtual character may include numerical settings such as an intimacy parameter and a basic requirement state. Usually, the behavior of the virtual character may affect the numerical changes of these settings. Therefore, after the corresponding action is generated, the action may further be used to determine the updated values corresponding to the intimacy parameter and the basic requirement, and update the intimacy parameter and the basic requirement. As shown in the behavior influence part in FIG. 2, the behavior influence part may include the influence of the behavior on the intimacy parameter. Influence rules of different behaviors on the intimacy parameter and the basic requirement may be pre-configured. For example, the behavior of giving an item may adjust the intimacy based on the number of times of giving the item and the level of the item. The influence rules may be preset based on actual application scenarios, and the embodiments of the present disclosure are not limited in this aspect.

In a possible embodiment, the character setting information includes immediate setting information used to represent attribute information of the target virtual character that changes during an interaction process; and the immediate setting information includes an intimacy parameter used to represent an intimacy degree between the user and the target virtual character;
correspondingly, the method may further include:
based on the interaction text, determining an intimacy change value corresponding to the target virtual character and the user.

As an example, an intimacy analysis model may be pre-trained, and the currently determined interaction text may be input into the intimacy analysis model, so as to obtain the intimacy change value. The intimacy analysis model may be obtained by pre-training conversation texts and intimacy change values labeled in the conversation texts based on a neural network model, which will not be repeated here.

As another example, an intimacy adjustment rule may be pre-set, and after the interaction text is determined, rule matching may be performed based on the interaction text and historical interaction texts, so that the intimacy change value may be determined based on the matched rule, and a new intimacy value may be determined based on the current intimacy value and the intimacy change value. For example, when the current intimacy value is 90, after the interaction text is determined, rule matching is performed based on the interaction text, and the intimacy change value is determined based on the matched rule. When the matched rule is that the interaction text does not meet the needs of the user, the change value −2 corresponding to the rule may be taken as the intimacy change value. As shown in the conversation influence part in FIG. 2, the conversation influence part may include the influence on the intimacy.

As another example, generally speaking, a player may have emotional companionship needs when chatting with a virtual character. In this embodiment, emotional recognition may be performed on the interaction text. When the recognized emotion is a positive emotion, it may indicate that the target virtual character has a higher degree of preference for the user, and in this case, the intimacy may be increased; when the recognized emotion is a negative emotion, it may indicate that the target virtual character has a lower degree of preference for the user, and in this case, the intimacy may be reduced. As an example, change values corresponding to an increase in intimacy and a decrease in intimacy may be set respectively, and different change values may also be set for different emotional levels.

Optionally, the intimacy change value may be determined based on the above multiple manners respectively, and the final intimacy change value may be obtained through weighted fusion. The weights of different manners may be preset based on the actual application scenario, which is not limited here.

The intimacy parameter in the immediate setting information is updated based on the intimacy change value. For example, the sum of the intimacy parameter in the immediate setting information and the intimacy change value may be taken as a new intimacy parameter in the immediate setting information to implement the update.

Thus, in the process of the user having a conversation with the target virtual character, the update of the intimacy parameter may be implemented based on the interaction text generated in the current round, and when the interaction text is generated in the next round, the text generation may be performed based on the updated intimacy parameter, so as to implement the update of the intimacy parameter between the target virtual character and the user, and at the same time provide accurate data support for the subsequent generation of the interaction text, thereby further improving the personification of the conversation of the target virtual character. The character setting information may include characteristics such as the identity and personality of the target virtual character, as well as its current emotion and the intimacy parameter with the user. When the interaction text is determined, the consistency between the interaction text and the characteristics of the target virtual character can be achieved based on the above parameters. Meanwhile, the memory information may include the long-term memory, the current state, and the surrounding environment of the target virtual character. The combination of the above information can ensure the consistency between the determined interaction text and the historical performance of the target virtual character, thereby improving the matching degree when interacting with the user based on the interaction text, improving the user experience, and at the same time improving the personification and personalized interaction of the target virtual character, thereby further improving the accuracy of controlling the virtual character.

In a possible embodiment, the method may further include:
storing the interaction information and the interaction text into conversation information corresponding to the target virtual character and the user.

The interaction information between the user and the target virtual character may have an impact on the follow-up plan of the target virtual character. For example, the target virtual character is a clerk in a bakery, and he is going to purchase raw materials tomorrow. When the user has a conversation with the target virtual character and tells the target virtual character that there is a discount activity in the supermarket S1 tomorrow, when generating a basic plan of the target virtual character for tomorrow based on the memory information subsequently, the interaction information provided by the user may be referred to for behavior generation. As shown in FIG. 2, the interaction between the user and the target virtual character can update the memory information.

In this embodiment, storage may be performed separately for each user to generate private memories of the target virtual character for each user. The target virtual character saves its conversation interaction texts with the users, that is, saves the interaction information input by the user and the interaction text corresponding to the target virtual character. The virtual character has different memories for different players, which can ensure the consistency of conversation interaction between the target virtual character and the user when generating interaction text subsequently, and at the same time, it can also provide more comprehensive and accurate data reference for the subsequent generation of the basic plan of the target virtual character, so that the user can influence the plot or behavior of the virtual character through conversation.

In a possible embodiment, an example implementation of outputting the interaction text may include:
based on the interaction text, determining expression information corresponding to the target virtual character when outputting the interaction text.

The expression information may be recognized by a pre-trained emotion classification model. The interaction text may be input into the emotion classification model to obtain the corresponding expression information. The emotion classification model may be obtained by training a neural network model with texts and expressions labeled corresponding to the texts, which will not be repeated here.

Controlling a facial expression of the target virtual character based on the expression information, and displaying the interaction text in the virtual scene interface and/or playing an interaction voice corresponding to the interaction text.

In this embodiment, the facial expression of the target virtual character may be driven to be displayed based on the expression information. Meanwhile, the interaction text may be displayed in the form of a bubble, and the corresponding interaction voice may also be played. Optionally, the mouth shape change of the target virtual character may also be driven based on the interaction text, which may be implemented by the related technologies of text-driven digital mouth shape in the art.

Therefore, through the above technical solutions, when controlling the target virtual character to output the interaction text, the expression display of the target virtual character may be further controlled to improve the expressiveness of the conversation effect of the target virtual character, and further improve the personification and personalization of the conversation between the target virtual character and the user.

In a possible embodiment, the method may further include:
determining whether the virtual scene includes an interactive virtual character that needs to perform conversation interaction.

The user can interact with a virtual character, and different virtual characters can also determine whether they want to interact with other virtual characters in the action process.

As an example, virtual characters VA1 and VA2 are both currently on their way to the supermarket, and whether they interact or not may be determined based on the distance between them and the memory information. For example, when the distance between them is less than a distance threshold and the memory information includes the conversation memory of them, it may be determined that the virtual characters VA1 and VA2 are interactive virtual characters that need to perform conversation interaction. The identification and judgment process is only for illustrative purposes, and the embodiments of the present disclosure are not limited thereto, and the identification and judgment process may be specifically configured based on actual application scenarios.

When there is the interactive virtual character(s), a conversation text corresponding to the interactive virtual character(s) is generated based on state information, character setting information, and memory information corresponding to the interactive virtual character(s), respectively, and the conversation text includes an interaction text corresponding to the interactive virtual character, or the conversation text includes interaction texts corresponding to the interactive virtual characters, respectively; and

the interactive virtual character(s) is controlled to perform conversation interaction based on the conversation text.

A prompt may be constructed based on the state information, the character setting information, and the memory information corresponding to the virtual characters VA1 and VA2, respectively, to determine the corresponding conversation text based on the LLM model. As an example, the memory information may be obtained by summarizing the part about the virtual character VA2 in the memory information of the virtual character VA1 and the part about the virtual character VA1 in the memory information of the virtual character VA2.

As an example, the conversation text may be represented as follows:
Virtual character VA1: Are you going to the S1 supermarket?
Virtual character VA2: Yes, there is a discount activity in the S1 supermarket.
Virtual character VA1: I happen to want to buy more X1.
Virtual character VA2: Okay, let's go together.

Furthermore, after the conversation text is determined, the interaction texts corresponding to the interactive virtual characters may be determined, and the interactive virtual objects may be further controlled to output their corresponding interaction texts in turn, so as to display the interaction process of the interactive virtual objects in the virtual scene. As shown in the conversation generation in FIG. 2, it is used to represent the part of generating the interaction text involved in the present disclosure.

Therefore, through the above technical solutions, in the process of controlling the virtual character based on the basic plan, the conversation interaction between different virtual characters can be generated in real time, which further improves the diversity of interaction.

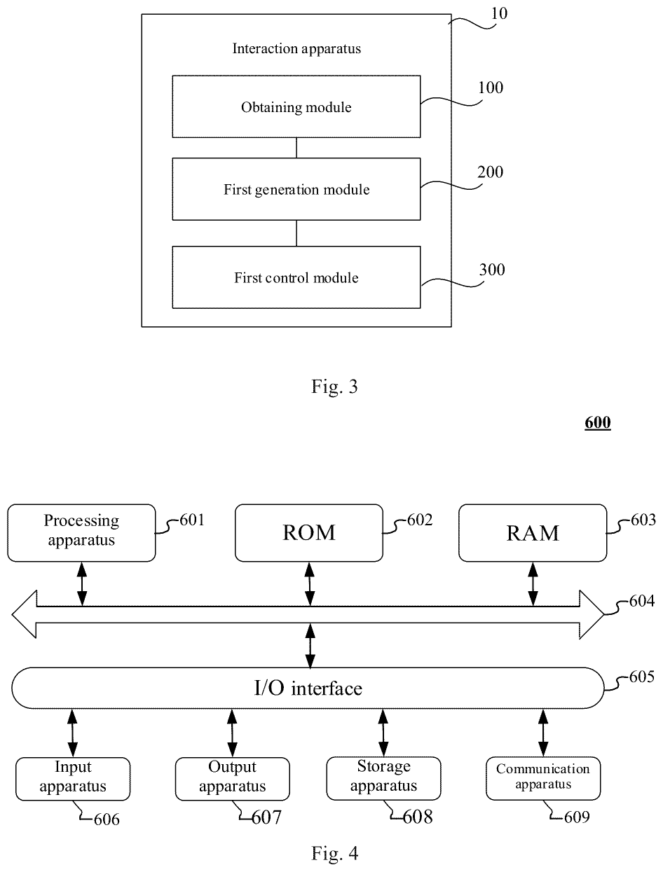

Based on the same inventive concept, the embodiments of the present disclosure further provides an interaction apparatus. As shown in FIG. 3, the apparatus 10 includes:
an obtaining module 100, configured to, in response to an interactive operation of a user on a target virtual character in a virtual scene interface, acquire interaction information corresponding to the interactive operation;
a first generation module 200, configured to, according to the interaction information and character information corresponding to the target virtual character, generate an interaction text corresponding to the target virtual character, in which the character information corresponding to the target virtual character includes character setting information and memory information of the target virtual character, the memory information includes event information and conversation information of the target virtual character within a historical period of time; and
a first control module 300, configured to control the target virtual character to output the interaction text.

Optionally, the memory information includes long-term memory information and short-term memory information, the long-term memory information includes the event information and the conversation information, and the short-term memory information includes a conversation context corresponding to the user; and
the first generation module includes:
a retrieval sub-module, configured to, based on the interaction information, retrieving, from the long-term memory information, associated memory information corresponding to the interaction information, and adding the associated memory information to the conversation context; and
a generation sub-module, configured to generate the interaction text according to the character setting information, the interaction information, and the short-term memory information.

Optionally, the short-term memory information further includes a basic plan of the target virtual character, the basic plan is used to control an action of the target virtual character, and the basic plan is determined by:
acquiring character setting information of the target virtual character, and according to the character setting information and a candidate position list corresponding to the target virtual character, generating various plans to be processed corresponding to the target virtual character;
acquiring memory information of the target virtual character, and according to the memory information and the various plans to be processed, generating an action corresponding to each of the plans to be processed performed by the target virtual character; and
generating an instruction sequence corresponding to each action, and splicing the instruction sequence based on time information corresponding to the action to obtain the basic plan.

Optionally, the character setting information includes basic setting information and immediate setting information, the basic setting information is used to represent attribute information of the target virtual character that remains unchanged during an interaction process, and the immediate setting information is used to represent attribute information of the target virtual character that changes during the interaction process.

Optionally, the immediate setting information includes an intimacy parameter used to represent an intimacy degree between the user and the target virtual character; and
the apparatus further includes:
a first determination module, configured to, based on the interaction text, determine an intimacy change value corresponding to the target virtual character and the user; and
an update module, configured to update the intimacy parameter in the immediate setting information based on the intimacy change value.

Optionally, the apparatus further includes:
a storage module, configured to store the interaction information and the interaction text into conversation information corresponding to the target virtual character and the user.

Optionally, the first control module includes:
a determination sub-module, configured to, based on the interaction text, determine expression information corresponding to the target virtual character when outputting the interaction text; and
a control sub-module, configured to control a facial expression of the target virtual character based on the expression information, and display the interaction text in the virtual scene interface and/or play an interaction voice corresponding to the interaction text.

Optionally, the apparatus further includes:
a second determination module, configured to determine whether the virtual scene includes an interactive virtual character that needs to perform conversation interaction;
a second generation module, configured to, in response to there being the interactive virtual character, generate a conversation text corresponding to the interactive virtual character based on state information, character setting information, and memory information corresponding to the interactive virtual character, respectively, in which the conversation text includes an interaction text corresponding to the interactive virtual character; and
a second control module, configured to control the interactive virtual character to perform conversation interaction based on the conversation text.

Reference is made to FIG. 4 below, which illustrates a schematic structural diagram of an electronic device 600 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 4 is merely an example, and should not pose any limitation to the functions and the range of use of the embodiments of the present disclosure.

As illustrated in FIG. 4, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 508 into a random-access memory (RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 4 illustrates the electronic device 600 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: in response to an interactive operation of a user on a target virtual character in a virtual scene interface, acquire interaction information corresponding to the interactive operation; according to the interaction information and character information corresponding to the target virtual character, generate an interaction text corresponding to the target virtual character, in which the character information corresponding to the target virtual character includes character setting information and memory information of the target virtual character, the memory information includes event information and conversation information of the target virtual character within a historical period of time; and control the target virtual character to output the interaction text.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the obtaining module may also be described as “a module configured to acquire interaction information corresponding to an interactive operation of a user on a target virtual character in a virtual scene interface in response to the interactive operation”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, Example 1 provides an interaction method, which includes:
in response to an interactive operation of a user on a target virtual character in a virtual scene interface, acquiring interaction information corresponding to the interactive operation;
according to the interaction information and character information corresponding to the target virtual character, generating an interaction text corresponding to the target virtual character, in which the character information corresponding to the target virtual character includes character setting information and memory information of the target virtual character, the memory information includes event information and conversation information of the target virtual character within a historical period of time; and
controlling the target virtual character to output the interaction text.

According to one or more embodiments of the present disclosure, Example 2 provides the method of Example 1, the memory information includes long-term memory information and short-term memory information, the long-term memory information includes the event information and the conversation information, and the short-term memory information includes a conversation context corresponding to the user; and
according to the interaction information and the character information corresponding to the target virtual character, the generating the interaction text corresponding to the target virtual character includes:
based on the interaction information, retrieving, from the long-term memory information, associated memory information corresponding to the interaction information, and adding the associated memory information to the conversation context; and
generating the interaction text according to the character setting information, the interaction information, and the short-term memory information.

According to one or more embodiments of the present disclosure, Example 3 provides the method of Example 2, the short-term memory information further includes a basic plan of the target virtual character, the basic plan is used to control an action of the target virtual character, and the basic plan is determined by:
acquiring character setting information of the target virtual character, and according to the character setting information and a candidate position list corresponding to the target virtual character, generating various plans to be processed corresponding to the target virtual character;
acquiring memory information of the target virtual character, and according to the memory information and the various plans to be processed, generating an action corresponding to each of the plans to be processed performed by the target virtual character; and
generating an instruction sequence corresponding to each action, and splicing the instruction sequence based on time information corresponding to the action to obtain the basic plan.

According to one or more embodiments of the present disclosure, Example 4 provides the method of Example 1, the character setting information includes basic setting information and immediate setting information, the basic setting information is used to represent the information of the attribute of the target virtual character that remains unchanged during an interaction process, and the immediate setting information is used to represent the attribute information of the target virtual character that changes during the interaction process.

According to one or more embodiments of the present disclosure, Example 5 provides the method of Example 4, the immediate setting information includes an intimacy parameter used to represent an intimacy degree between the user and the target virtual character; and
the method further includes:
based on the interaction text, determining an intimacy change value corresponding to the target virtual character and the user; and
updating the intimacy parameter in the immediate setting information based on the intimacy change value.

According to one or more embodiments of the present disclosure, Example 6 provides the method of Example 1, where the method further includes:
storing the interaction information and the interaction text into conversation information corresponding to the target virtual character and the user.

According to one or more embodiments of the present disclosure, Example 7 provides the method of Example 1, the controlling the target virtual character to output the interaction text includes:
based on the interaction text, determining expression information corresponding to the target virtual character when outputting the interaction text; and
controlling a facial expression of the target virtual character based on the expression information, and displaying the interaction text in the virtual scene interface and/or playing an interaction voice corresponding to the interaction text.

According to one or more embodiments of the present disclosure, Example 8 provides the method of Example 1, the method further includes:
determining whether the virtual scene includes an interactive virtual character that needs to perform conversation interaction;
in response to there being the interactive virtual character, generating a conversation text corresponding to the interactive virtual character based on state information, character setting information, and memory information corresponding to the interactive virtual character, respectively, in which the conversation text includes an interaction text corresponding to the interactive virtual character; and
controlling the interactive virtual character to perform conversation interaction based on the conversation text.

According to one or more embodiments of the present disclosure, Example 9 provides an interaction apparatus, including:
an obtaining module, configured to, in response to an interactive operation of a user on a target virtual character in a virtual scene interface, acquire interaction information corresponding to the interactive operation;
a first generation module, configured to, according to the interaction information and character information corresponding to the target virtual character, generate an interaction text corresponding to the target virtual character, in which the character information corresponding to the target virtual character includes character setting information and memory information of the target virtual character, the memory information includes event information and conversation information of the target virtual character within a historical period of time; and
a first control module, configured to control the target virtual character to output the interaction text.

According to one or more embodiments of the present disclosure, Example 10 provides a computer-readable medium having a computer program stored thereon, when the program is executed by a processing apparatus, steps of the method of any one of Examples 1-8 are implemented.

According to one or more embodiments of the present disclosure, Example 11 provides an electronic device, which includes:
a storage apparatus having a computer program stored thereon; and
a processing apparatus, configured to execute the computer program in the storage apparatus to implement steps of the method of any one of Examples 1-8.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. An interaction method, comprising:
in response to an interactive operation of a user on a target virtual character in a virtual scene interface, acquiring interaction information corresponding to the interactive operation;
according to the interaction information and character information corresponding to the target virtual character, generating an interaction text corresponding to the target virtual character, wherein the character information corresponding to the target virtual character comprises character setting information and memory information of the target virtual character, the memory information comprises event information and conversation information of the target virtual character within a historical period of time; and
controlling the target virtual character to output the interaction text.

2. The method according to claim 1, wherein the memory information comprises long-term memory information and short-term memory information, the long-term memory information comprises the event information and the conversation information, and the short-term memory information comprises a conversation context corresponding to the user; and
according to the interaction information and the character information corresponding to the target virtual character, the generating the interaction text corresponding to the target virtual character comprises:
based on the interaction information, retrieving, from the long-term memory information, associated memory information corresponding to the interaction information, and adding the associated memory information to the conversation context; and
generating the interaction text according to the character setting information, the interaction information, and the short-term memory information.

3. The method according to claim 2, wherein the short-term memory information further comprises a basic plan of the target virtual character, the basic plan is used to control an action of the target virtual character, and the basic plan is determined by:
acquiring character setting information of the target virtual character, and according to the character setting information and a candidate position list corresponding to the target virtual character, generating various plans to be processed corresponding to the target virtual character;
acquiring memory information of the target virtual character, and according to the memory information and the various plans to be processed, generating an action corresponding to each of the plans to be processed performed by the target virtual character; and
generating an instruction sequence corresponding to each action, and splicing the instruction sequence based on time information corresponding to the action to obtain the basic plan.

4. The method according to claim 1, wherein the character setting information comprises basic setting information and immediate setting information, the basic setting information is used to represent attribute information of the target virtual character that remains unchanged during an interaction process, and the immediate setting information is used to represent attribute information of the target virtual character that changes during the interaction process.

5. The method according to claim 4, wherein the immediate setting information comprises an intimacy parameter used to represent an intimacy degree between the user and the target virtual character; and
the method further comprises:
based on the interaction text, determining an intimacy change value corresponding to the target virtual character and the user; and
updating the intimacy parameter in the immediate setting information based on the intimacy change value.

6. The method according to claim 1, further comprising:
storing the interaction information and the interaction text into conversation information corresponding to the target virtual character and the user.

7. The method according to claim 1, wherein the controlling the target virtual character to output the interaction text comprises:
based on the interaction text, determining expression information corresponding to the target virtual character when outputting the interaction text; and
controlling a facial expression of the target virtual character based on the expression information, and displaying the interaction text in the virtual scene interface and/or playing an interaction voice corresponding to the interaction text.

8. The method according to claim 1, further comprising:
determining whether the virtual scene comprises an interactive virtual character that needs to perform conversation interaction;
in response to there being the interactive virtual character, generating a conversation text corresponding to the interactive virtual character based on state information, character setting information, and memory information corresponding to the interactive virtual character, respectively, wherein the conversation text comprises an interaction text corresponding to the interactive virtual character; and
controlling the interactive virtual character to perform conversation interaction based on the conversation text.

9. A non-transitory computer-readable medium having a computer program stored thereon, wherein when the program is executed by a processing apparatus, steps of an interaction method are implemented, the method comprises:
in response to an interactive operation of a user on a target virtual character in a virtual scene interface, acquiring interaction information corresponding to the interactive operation;
according to the interaction information and character information corresponding to the target virtual character, generating an interaction text corresponding to the target virtual character, wherein the character information corresponding to the target virtual character comprises character setting information and memory information of the target virtual character, the memory information comprises event information and conversation information of the target virtual character within a historical period of time; and
controlling the target virtual character to output the interaction text.

10. An electronic device, comprising:
a storage apparatus, having a computer program stored thereon; and
a processing apparatus, configured to execute the computer program in the storage apparatus to:
in response to an interactive operation of a user on a target virtual character in a virtual scene interface, acquire interaction information corresponding to the interactive operation;
according to the interaction information and character information corresponding to the target virtual character, generate an interaction text corresponding to the target virtual character, wherein the character information corresponding to the target virtual character comprises character setting information and memory information of the target virtual character, the memory information comprises event information and conversation information of the target virtual character within a historical period of time; and
control the target virtual character to output the interaction text.

11. The electronic device according to claim 10, wherein the memory information comprises long-term memory information and short-term memory information, the long-term memory information comprises the event information and the conversation information, and the short-term memory information comprises a conversation context corresponding to the user; and
the processing apparatus is further to:
based on the interaction information, retrieve, from the long-term memory information, associated memory information corresponding to the interaction information, and add the associated memory information to the conversation context; and
generate the interaction text according to the character setting information, the interaction information, and the short-term memory information.

12. The electronic device according to claim 11, wherein the short-term memory information further comprises a basic plan of the target virtual character, the basic plan is used to control an action of the target virtual character, and the basic plan is determined by:
acquiring character setting information of the target virtual character, and according to the character setting information and a candidate position list corresponding to the target virtual character, generating various plans to be processed corresponding to the target virtual character;
acquiring memory information of the target virtual character, and according to the memory information and the various plans to be processed, generating an action corresponding to each of the plans to be processed performed by the target virtual character; and
generating an instruction sequence corresponding to each action, and splicing the instruction sequence based on time information corresponding to the action to obtain the basic plan.

13. The electronic device according to claim 10, wherein the character setting information comprises basic setting information and immediate setting information, the basic setting information is used to represent attribute information of the target virtual character that remains unchanged during an interaction process, and the immediate setting information is used to represent attribute information of the target virtual character that changes during the interaction process.

14. The electronic device according to claim 13, wherein the immediate setting information comprises an intimacy parameter used to represent an intimacy degree between the user and the target virtual character; and
the processing apparatus is further to:
based on the interaction text, determine an intimacy change value corresponding to the target virtual character and the user; and
update the intimacy parameter in the immediate setting information based on the intimacy change value.

15. The electronic device according to claim 10, wherein the processing apparatus is further to:
store the interaction information and the interaction text into conversation information corresponding to the target virtual character and the user.

16. The electronic device according to claim 10, wherein the processing apparatus is further to:
based on the interaction text, determine expression information corresponding to the target virtual character when outputting the interaction text; and
control a facial expression of the target virtual character based on the expression information, and display the interaction text in the virtual scene interface and/or play an interaction voice corresponding to the interaction text.

17. The electronic device according to claim 10, wherein the processing apparatus is further to:
determine whether the virtual scene comprises an interactive virtual character that needs to perform conversation interaction;
in response to there being the interactive virtual character, generate a conversation text corresponding to the interactive virtual character based on state information, character setting information, and memory information corresponding to the interactive virtual character, respectively, wherein the conversation text comprises an interaction text corresponding to the interactive virtual character; and
control the interactive virtual character to perform conversation interaction based on the conversation text.
